(19) United States
(12) Patent Application Publication
(10) Pub. No.: US 2026/0345414 A1
(43) Pub. Date: Nov. 5, 2026

(54) EXERCISE CHAIR

(71) Applicant: Ping-Yu LIU, Taipei City (TW)

(72) Inventor: Ping-Yu LIU, Taipei City (TW)

(21) Appl. No.: 19/198,050

(22) Filed: May 4, 2025

(51) Int. Cl. A61G 15/00; A47C 7/44; A61G 15/12; A61H 15/00; A63B 23/02

(52) U.S. Cl. CPC A61G 15/007; A47C 7/44; A61G 15/125; A61H 15/00; A63B 23/0233; A61H 2015/0014; A61H 2201/0149; A63B 2208/0233

(57) ABSTRACT

An exercise chair includes: a main body with a pivot part; a backrest pivoted to the pivot part and rotatable to change a backrest angle; a movable support rod with an end having at least one wheel for touching a floor and another end pivoted with the rear of the backrest for changing the touchdown position of the wheel; a first limiting device connected to the pivot part for providing sufficient support to limit the backrest angle and the wheel touchdown position; a second limiting device arranged on a second extension part for limiting and stopping the movement of the movable support rod to prevent tipping over backwards when the first limiting device is loose or broken; and an elastic restoring element connected between the backrest and the main body for restoring the backrest to a predetermined tilt angle, so as to minimize occupied space of the exercise chair.

### BACKGROUND OF THE DISCLOSURE

### Technical Field

The present disclosure relates to an exercise chair, and particularly relates to an exercise chair provided for users to sit in a sitting position for supine or back stretch exercises.

### Description of the Related Art

Most of the exercise equipment used for supine or back stretch exercises takes up a lot of space, mainly because the user's center of gravity shifts backward greatly during supine or back stretches, so the exercise equipment must be designed with a backward extending support structure to avoid tipping over during use.

Due to the extending support structure, the exercise equipment often takes up more space, and when the exercise equipment is normally placed in the living environment, it takes up the living space of the place where it is used. Furthermore, the exercise equipment is usually bulky and inconvenient to store, so that it is inconvenient to move it out and arrange it to the operation position before each time of use and then store it in the storage place after each use. Obviously, it is necessary to improve the convenience of use and the practicality of the related-art equipment.

### SUMMARY OF THE DISCLOSURE

It is a primary objective of the present disclosure to provide an exercise chair that can be used as a regular chair when it is static, and can be used as an exercise equipment when it is operated, and the exercise chair does not occupy too much space when it is used as a chair, and has the effect of preventing tipping over when it is used as an exercise equipment with sufficient stabilization.

To achieve the forementioned objective, the present disclosure provides an exercise chair which includes: a main body, with a pivot part; a backrest, with a portion near the seat being pivoted to the pivot part, such that the backrest is rotatable relative to the pivot part of the main body to change the tilt angle of the backrest; at least one movable support rod, with an end facing a floor and provided with at least one wheel, for touching the floor, and an end of the movable support rod away from the floor being pivoted to a rear portion of the backrest farther away from the seat, and having a first limiting device which is a length adjustable mechanism arranged on the pivot part for providing sufficient support to the rear of the backrest to adjust and limit the tilt angle of the backrest, and adjust and limit the touchdown position of the wheel of the movable support rod; thereby when the first limiting device is loose or broken, the second limiting device of the second extension part limits and stops the movement of movable support rod to prevent the exercise chair from tipping over backwards.

In some embodiments, at an end of the second limiting device, provided with an embedding plate, having a recessed embedding portion that can be embedded and connected to the movable support rod.

The exercise chair further includes at least one elastic restoring element connected between the backrest and the main body, such that when no external force is exerted on the backrest, the elastic restoring element can restore the position of the backrest relative to the seat and hold the backrest at a predetermined tilt angle to allow the exercise chair to occupy the least space.

In some embodiments, the backrest is provided with a plurality of rotatable flexible rollers.

In some embodiments, the front of the backrest is in a convex arc shape.

In some embodiments, the exercise chair further includes a headrest connected to the backrest.

In some embodiments, two sides of the seat are respectively provided with an armrest.

Compared with the related art, the exercise chair of the present disclosure can be used as a regular chair when not in operation. When the exercise chair is used as a regular chair, the elastic restoring element is used to prevent the exercise chair from occupying too much space. When the exercise chair is operated, the backrest can be rotated relative to the main body to change the tilt angle, and can be used as an exercise equipment to let users do supine or back stretch exercises. During exercise, the first limiting device of the pivot part can provide sufficient support behind the backrest, adjust and limit the backrest angle and the touchdown position of the movable support rod wheel. In addition, the second limiting device provided in the second extension part can limit and stop movement of the movable support rod when the first limiting device is loose or broken, so as to prevent the exercise chair from tipping over backwards, thereby making the use of the exercise chair safer.

The following preferred embodiments are provided to illustrate the present disclosure and they are described with reference to the accompanying drawings:

### BRIEF DESCRIPTION OF THE DRAWINGS

FIG. 1 is a perspective view of an exercise chair in accordance with a preferred embodiment of the present disclosure;

FIG. 2 is another perspective view of the exercise chair in accordance with the preferred embodiment of the present disclosure;

FIG. 3 is a schematic view of a bracket as depicted in FIG. 1, without being exerted by an external force;

FIG. 4 a schematic view of the bracket as depicted in FIG. 1, being tilted by an external force; and

FIG. 5 a schematic view of the bracket as depicted in FIG. 1, being tilted by an external force, and when a first limiting device is loose or broken, a second limiting device of a second extension part can limit and stop the movement of the movable support rod to prevent the exercise chair from tipping over backwards.

### DESCRIPTION OF THE PREFERRED EMBODIMENTS

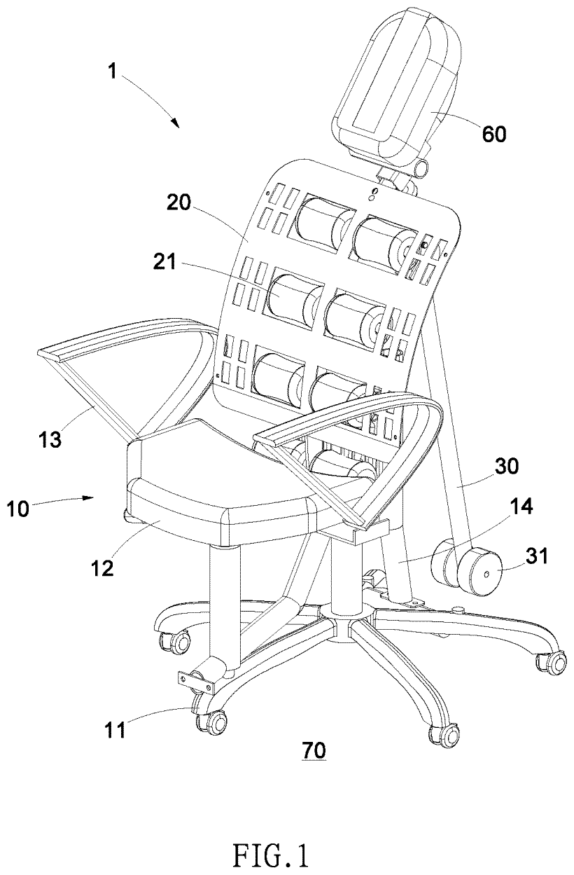

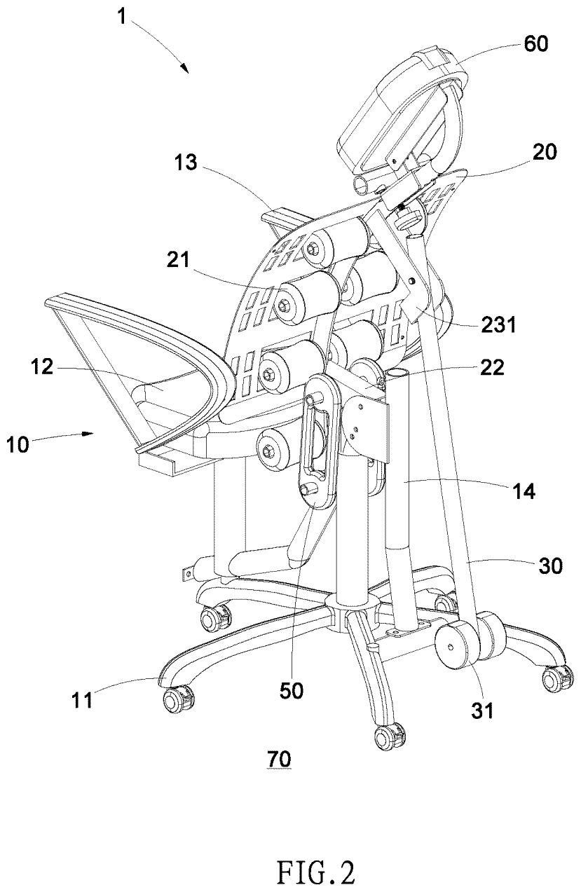

In the embodiments as shown in FIGS. 1 to 3, the exercise chair 1 includes a main body 10, a backrest 20, at least one limiting device 141, at least one movable support rod 30, at least one elastic restoring element 50, and a headrest 60.

The main body 10 includes main components such as a plurality of legs 11, a cushion 12, a plurality of armrests 13, and a pivot part 14. The cushion 12 is arranged above the legs 11 and provided for a user to sit on it in a normal sitting position, the front of the backrest 20 is in a convex arc shape and provided with a plurality of rotatable flexible rollers 21 (which can be made of foam). When the user's back leans against the backrest 20, the user's back will be in contact with the rotatable flexible rollers 21. The armrests 13 are arranged on both sides of the seat 10 to support the user's hands or arms or provided for the user to grasp. The pivot portion 14 is arranged above the legs 11 and towards the rear of the backrest 20.

The rear portion of backrest 20 near the main body 10 is provided with a first extension part 22, and the first extension part 22 is pivoted to the pivot part 14.

An end of the movable support rod 30 facing a floor 70 is provided with at least one wheel 31, and the wheel 31 is able to contact with the floor 70; another end of the movable support rod 30 extends towards an end of the backrest 20 away from the cushion 12 and is pivoted to a second extension part 23 at the rear of the backrest 20, the second extension part 23 is provided with a second limiting device 231, an end of the second limiting device 231 is provided with an embedding plate 2311 and a recessed embedding portion 2312 embedded and connected to the movable support rod 30.

The first limiting device 141 is connected with the pivot part 14 for providing sufficient support to the backrest 20 when the backrest 20 tilts backward. The first limiting device 141 adjusts and limits the tilt angle of the backrest, adjusting and limiting the touchdown position of the wheel of the movable support rod, such that if the first limiting device 141 is loose or broken, the second limiting device 231 will be able to limit and stop the movement of the movable support rod 30, so as to prevent the exercise chair from tipping over backwards.

The elastic restoring element 50 is arranged between the backrest 20 and the main body 10, so that when the backrest 20 tilts and extends backward, the elastic restoring element 50 can accumulate elastic restoring forces to pull and restore the backrest 20 to its original position, and when no external force is exerted on the backrest 20, the backrest 20 restores to a predetermined tilt angle that allows the exercise chair to occupy the least space.

The headrest 60 is connected to the top end of backrest 20 for supporting the user's head, and the headrest 60 as shown in the figures is connected to the backrest 20. In actual implementation, a height adjustment mechanism (not shown in the figure) can be installed between the headrest 60 and the backrest 20 for adjusting the headrest 60 to the most suitable height for use.

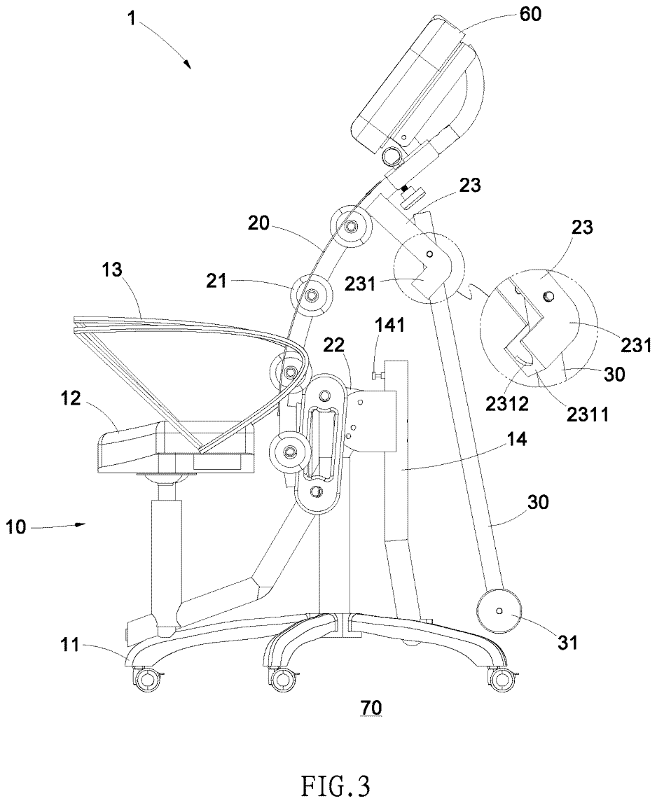

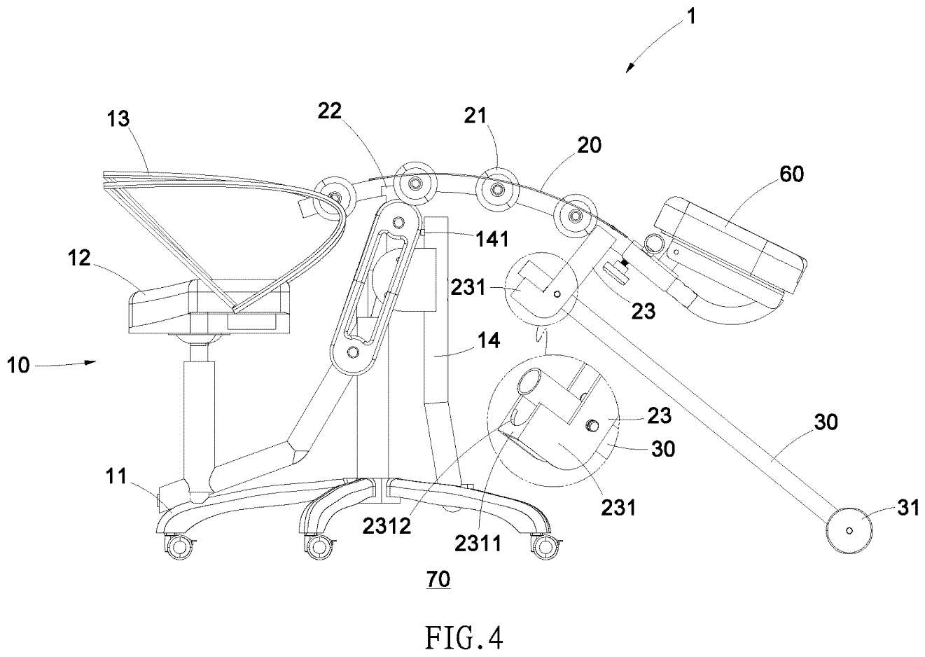

In FIGS. 3 and 4, since the first extension part 22 is connected to the pivot part 14, the backrest 20 can rotate relative to the pivot part 14, thereby changing the tilt angle of the backrest 20, and the wheel 31 located at an end of the movable support rod 30 can touch the floor 70 according to the degree of inclination and gradually roll along the floor 70 to a larger support range.

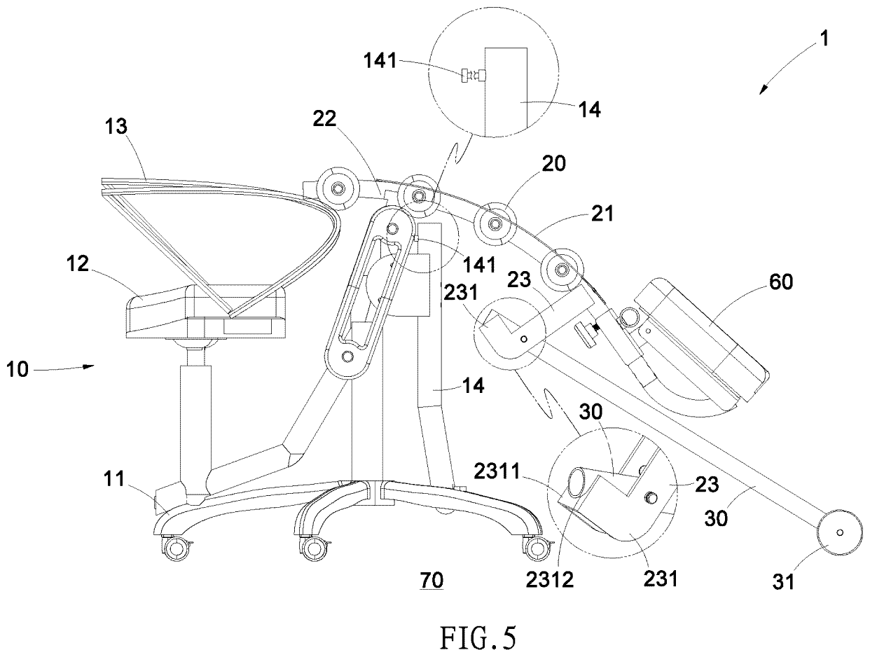

In FIG. 5, the first extension part 22 is connected to the pivot part 14, so that the backrest 20 can rotate relative to the pivot part 14, thereby changing the tilt angle of the backrest 20, and the wheel 31 located at an end of the movable support rod 30 can touch the floor 70 according to the level of inclination and gradually roll along the floor 70 to a larger support range. When the backrest 20 is tilted by an external force and the first limiting device 141 is loose or broken, the second limiting device 231 of the second extension part 23 can limit and stop the movement of the movable support rod 30, thereby preventing the exercise chair 1 from tipping over backwards.

In summation of the description above, the exercise chair 1 can be used as a regular chair and can also be used as an exercise equipment due to the allowable stretchability between the backrest 20 and the seat 10. When the exercise chair 1 is used as a regular chair, the elastic restoring element 50 can keep the backrest 20 at a predetermined minimum tilt angle relative to the main body 10. At this time, the movable support rod 30 will be close to the main body 10, naturally returning to a minimum original volume, and will not occupy too much space (as shown in FIG. 3). On the contrary, when the exercise chair 1 is used as an exercise equipment, the backrest 20 can be tilted backward by exerting force to the backrest 20 through the user's back, thereby providing the user to proceed a supine or back stretch exercise in a sitting position. At the same time, the first limiting device 141 connected to the pivot part 14 can provide sufficient support when the backrest 20 is tilted backward. In addition to the aforementioned embodiments, the implementation of the first limiting device may also be connected to the first extension part 22. The first limiting device 141 can limit and stop the rotating of the first extension part 22, such that when the first limiting device 141 is loose or broken, the second limiting device 231 can limit and stop the movement of the movable support rod 30 to prevent the exercise chair 1 from tipping over backwards, so as to strengthen the safety of the exercise chair.

While the above describes the specific embodiments of this disclosure, these embodiments are not intended to limit the scope of the disclosure, and any simple replacements and equivalent changes made in accordance with the scope of this disclosure or the content of the patent specification shall be covered by the scope of the disclosure as defined in the appended claims.

What is claimed is:

1. An exercise chair, comprising:
a main body, with a pivot part;
a backrest, with a portion near the seat being pivoted to the pivot part, such that the backrest is rotatable relative to the pivot part to change the tilt angle of the backrest relative to the seat;
a first limiting device, being a length adjustable mechanism connected to the pivot part, for providing sufficient support when the backrest is tilted backwards, adjusting and limiting the tilt angle of the backrest; and
a movable support rod, with an end facing a floor and being provided with at least one wheel, the wheel being provided for touching the floor, and another rend of the movable support rod being pivoted to the rear of the backrest away from the seat, for limiting the tilt angle of the backrest relative to the seat and limiting the touchdown position of the wheel of the movable support rod accordingly;
thereby, when the first limiting device is loose or broken, the second limiting device of the second extension part limits and stops the movement of the movable support rod to prevent the exercise chair from tipping over backwards.

2. The exercise chair according to claim 1, wherein the second limiting device comprises an embedding plate disposed at an end thereof, and a recessed embedding portion capable of embedding the movable support rod.

3. The exercise chair according to claim 1, further comprising at least one elastic restoring element is connected between the backrest and the main body, and when no external force is exerted on the backrest, the elastic restoring element holds the backrest at a predetermined tilt angle relative to the seat.

4. The exercise chair according to claim 2, further comprising at least one elastic restoring element is connected between the backrest and the main body, and when no external force is exerted on the backrest, the elastic restoring element holds the backrest at a predetermined tilt angle relative to the seat.

5. The exercise chair according to claim 1, wherein the backrest is provided with a plurality of rotatable flexible rollers.

6. The exercise chair according to claim 2, wherein the backrest is provided with a plurality of rotatable flexible rollers.

7. The exercise chair according to claim 3, wherein the backrest is provided with a plurality of rotatable flexible rollers.

8. The exercise chair according to claim 4, wherein the backrest is provided with a plurality of rotatable flexible rollers.

9. The exercise chair according to claim 1, wherein the front of the backrest is substantially in an arc convex shape.

10. The exercise chair according to claim 2, wherein the front of the backrest is substantially in an arc convex shape.

11. The exercise chair according to claim 3, wherein the front of the backrest is substantially in an arc convex shape.

12. The exercise chair according to claim 4, wherein front of the backrest is substantially in an arc convex shape.

13. The exercise chair according to claim 1, further comprising a headrest connected to the backrest.

14. The exercise chair according to claim 2, further comprising a headrest connected to the backrest.

15. The exercise chair according to claim 3, further comprising a headrest connected to the backrest.

16. The exercise chair according to claim 4, further comprising a headrest connected to the backrest.

17. The exercise chair according to claim 1, wherein the main body comprises two armrests respectively arranged on two sides thereof.

18. The exercise chair according to claim 2, wherein the main body comprises two armrests respectively arranged on two sides thereof.

19. The exercise chair according to claim 3, wherein the main body comprises two armrests respectively arranged on two sides thereof.

20. The exercise chair according to claim 4, wherein the main body comprises two armrests respectively arranged on two sides thereof.
